(19) United States
(12) Patent Application Publication
(10) Pub. No.: US 2011/0199589 A1
(43) Pub. Date: Aug. 18, 2011

(54) ANTENNA DEVICE

(76) Inventor: Sven Zuehlsdorff, Langenhagen (DE)

(21) Appl. No.: 12/734,533

(22) PCT Filed: Sep. 15, 2008
(86) PCT No.: PCT/EP2008/062227

§ 371 Date: Jul. 29, 2010

(30) Foreign Application Priority Data
Nov. 9, 2007 (DE) 10 2007 053 421.5

(51) Int. Cl. G03B 21/26; H01Q 1/22

(52) U.S. Cl. 353/94; 343/721

(57) ABSTRACT

An antenna device for connection to a calculation device, having a projection device for generating a virtual image.

### FIELD OF THE INVENTION

The present invention relates to an antenna device.

### BACKGROUND INFORMATION

United States Published Patent Application No. 2006/0244825 A1 discusses a multifunction communication and navigation system that contains a head-up display module, a GPS module, and a Bluetooth module. All the components of the module are disposed in a housing, and disposed on an instrument panel of a motor vehicle. The housing rests flat on the instrument panel. Provided on the upper side is a display area whose image is reflected in the windshield of the vehicle, so that a virtual image is visible to the driver of the vehicle. All the components are disposed in the housing of the system.

### SUMMARY OF THE INVENTION

The antenna apparatus according to the exemplary embodiments and/or exemplary methods of the present invention, having the features described herein, has, in contrast thereto, the advantage that an antenna device has a projection device and at the same time is suitable for being connected to a calculation device. As a result, the calculation device and the antenna device can be physically separated from one another. It is thereby possible to dispose both the projection device and the antenna device in space-saving fashion in a housing at a suitable location in the vehicle, while the calculation device can be provided in particular at a location suitable for operation by a user. If the calculation device furthermore also has an additional display, an observer can view a display on the calculation device in addition to the display that is depicted by the projection device. At the same time, the antenna device can also be placed appropriately for good reception.

Advantageous refinements of and improvements to the antenna device indicated in the independent claim are possible as a result of the features set forth in the dependent claims. It is advantageous to provide multiple light-emitting diodes in order to generate light for depiction of the virtual image in the antenna device. Multiple light-emitting diodes are, if applicable, capable of depicting only coarse graphical information, but on the other hand they can also be installed in space-saving fashion and have low power consumption, so that they can easily be mounted on the antenna device. It is advantageous in this context to configure different symbols by the fact that the multiple light-emitting diodes are at least in part separately triggerable, and symbols of different kinds can thus be generated by the projection device and thereby depicted in a virtual image.

It is further advantageous to position the antenna device physically independently of the calculation device. An optimum position both for protection but also for antenna reception can thereby be guaranteed. The calculation device can be disposed at any desired location in the vehicle. This is advantageous in particular in a vehicle in which the calculation device should be disposed in a field of view, or within reach, of a driver, while the antenna device can be disposed on the instrument panel even at a location inaccessible to the driver while driving.

It is further advantageous to provide an interface through which image information can be transferred bidirectionally to the projection device for depiction in the virtual image, while on the other hand information received by the antenna device can be transferred via a suitable interface to the calculation device.

It is further advantageous to provide on the antenna device an operating element for switching the projection device on or off. Projection can thereby easily be activated or deactivated by a user with no need to perform an adjustment on the calculation device itself.

It is further advantageous to provide an optical device for adjusting the virtual image on the antenna device. An image depiction can thereby be corrected in simple fashion.

Particularly advantageously, the antenna device has a receiving unit for receiving a satellite signal. On the one hand, corresponding receiving units can be implemented using little installation space; on the other hand, reception quality can possibly be improved by suitable orientation of the receiving unit.

It is further advantageous to use the antenna device to receive a traffic message data service, for example to receive a TMC (traffic message channel). It is thereby possible, for example, to omit any further connection of a calculation device, embodied as a navigation unit, to a car radio. Current traffic information for route calculation is nevertheless available in the navigation unit.

For easier attachment, the antenna device advantageously has an attachment unit for attaching the antenna device to a dashboard of a motor vehicle.

It is especially advantageous to use an antenna device according to the exemplary embodiments and/or exemplary methods of the present invention in a motor vehicle, since here on the one hand a projection surface, for example the windshield, is available, and on the other hand a physical separation between the operating unit and the calculating unit is possibly particularly advantageous for reasons of easier operability.

Exemplifying embodiments of the invention are depicted in the drawings and explained further in the description below.

### BRIEF DESCRIPTION OF THE DRAWINGS

FIG. 1 shows a schematic configuration of an antenna device according to the present invention, connected to a calculation device.

FIG. 2 shows an installation example for an antenna device according to the present invention in a motor vehicle.

FIG. 3 is a side view of an installed antenna device according to the present invention.

FIG. 4 is a respective plan view of an exemplary embodiment of an antenna device according to the present invention.

FIG. 5 is another respective plan view of an exemplary embodiment of an antenna device according to the present invention.

### DETAILED DESCRIPTION

The antenna device according to the present invention can be used for any signal reception purposes. Use in a motor vehicle is particularly advantageous, so that the invention will be explained hereinafter using the example of an antenna device having a projection unit in a motor vehicle.

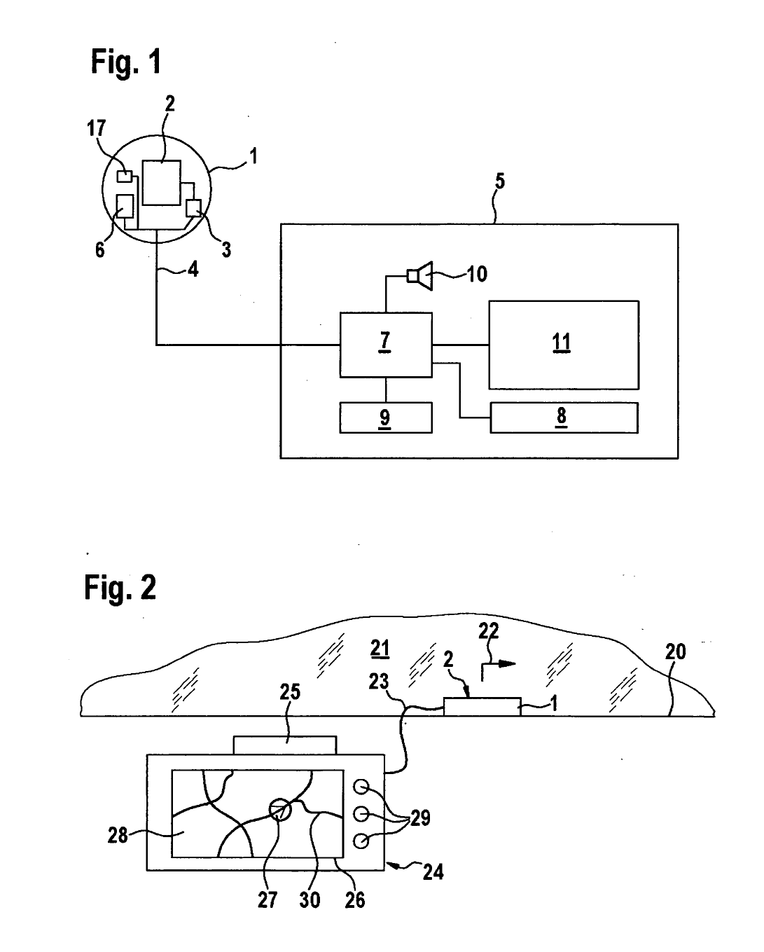

FIG. 1 shows an antenna device 1 that has a display 2 that serves to generate a virtual image in the vehicle. Antenna device 1 positioned in the vehicle in such a way that the display image of display 2 is deflected toward a surface in which display 2 is reflected. This reflective surface can be, for example, the windshield, but also another reflective or at least partly reflective surface. Display area 2 is triggered by a triggering unit 3 that is in turn connected to an interface 4. Antenna device 1 is connected via interface 4 to a calculation device 5 in the vehicle. Antenna device 1 likewise has a receiving unit 6. In a first embodiment, receiving unit 6 is embodied as a receiving device for a satellite position signal. In a further embodiment, a transmitting unit 17, for example for mobile radio signals, can also be disposed in the antenna device in addition to the receiving unit. Receiving unit 6 and, in the other embodiment, transmitting unit 17 in supplementary fashion, are also connected via interface 4 to calculation device 5.

Calculation device 5 is embodied, for example, as a portable navigation system. Calculation device 5 may be disposed at a location in the vehicle that is easily accessible for a driver. Calculation device 5 has a data processing unit, for example a microprocessor 7, as well as an operating unit 8, a memory device 9, an acoustic output unit 10, and a further, which may be a planar display 11. By way of operating unit 8, a destination can be inputted via calculation device 5 that is embodied as a navigation system. Microprocessor 7 reads out a received signal of a satellite positioning system from antenna device 1 via receiving unit 6. With access to memory 9, in which a digital road map of a road network is stored, microprocessor 7 calculates a driving route from the present position of the vehicle in which antenna device 1 and calculation device 5 are disposed, to the inputted destination. Driving instructions are subsequently outputted to the driver via display 11 and/or via acoustic output unit 10. The driving instructions are outputted as a function of the present position, which is ascertained via receiving unit 6.

In a further embodiment, calculation device 5 can also be embodied as a receiving unit for a broadcast radio program, by the fact that the received broadcast radio signals are processed, which may be digitally, by receiving unit 6. In particular, a signal of a traffic message data service, for example a TMC (traffic message channel), is advantageously received via the antenna device. A wire-conducted embodiment of interface 4 from antenna device 1 to a calculation device 5 constituting an antenna component may also be used in this context. The received traffic data can be outputted and/or used for route calculation, for example in order to circumvent blocked road segments.

In a first embodiment, interface 4 is embodied in wire-conducted fashion. Interface 4 can be embodied, for example, as a USB interface that simultaneously also supplies antenna device 1 with an operating voltage. In a further embodiment, antenna device 1 can also have an independent power supply, for example a battery. In a further embodiment, interface 4 can also be embodied as a radio interface.

When driving instructions, for example turn advisories, are outputted, microprocessor 7 determines symbols that are to be depicted, for example an arrow to the right, an arrow to the left, or an arrow straight ahead. As a supplement to the signals outputted in display 11 or via acoustic output unit 10, the projection unit of the antenna device, namely display 2, is caused to depict a corresponding arrow depiction. Mirror-image depiction for overlay into a mirror surface must be taken into account here. A corresponding command is outputted to triggering device 3.

FIG. 2 depicts an installation example in a motor vehicle. Antenna device 1 is mounted on an instrument panel 20 of the vehicle. It is, for example, adhesively bonded there or attached via a magnetic holder. Light from projection device 2 is radiated toward a windshield 21, so that a symbol 22, reflected in the windshield, is visible to an observer as a virtual image. Antenna device 1 is connected via a cable connection 23 to a portable navigation device 24. Portable navigation device 24 is releasably attached to instrument panel 20 via a holder 25. The receiving device inside antenna device 1 furthermore ascertains, via radio reception of a satellite position signal, a position of the vehicle in a road map, this position, characterized by a symbol 27, being depicted in a road map 28 in a display area 26 of navigation device 24. Disposed adjacent to display 26 on a front side of mobile navigation device 24 are operating elements 29 with which the navigation device is controllable. In the present case the vehicle, proceeding from position 27, will turn onto an upcoming cross street 30. Symbol 22 is correspondingly overlaid into the windshield as a right-turn arrow, so that a driver can perceive the symbol, depicted as a virtual image, even if he or she is not currently looking at map depiction 28 in mobile navigation device 24. Antenna device 1 is movable on a surface of instrument panel 20, so that a position for overlaying symbol 22 that is suitable for a driver of the vehicle can be achieved. In addition, reception of the satellite position signal can be optimized, if applicable, by displacing display device 1 on instrument panel 20.

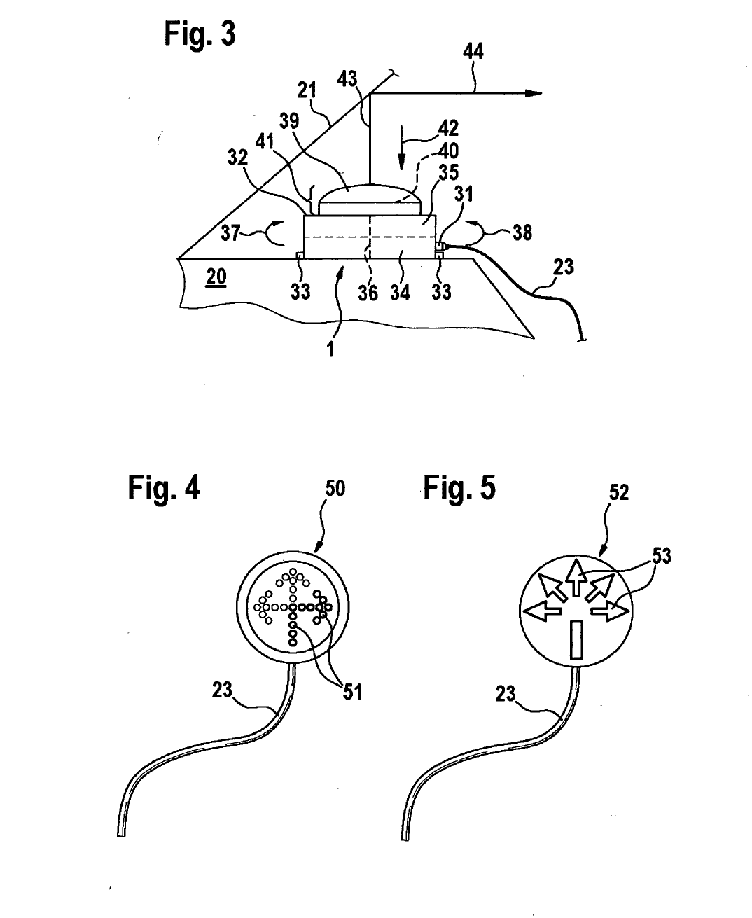

FIG. 3 depicts antenna device 1 in detail. Cable connection 23 is guided via a plug connector 31 into a housing 32 of antenna device 1. In the exemplifying embodiment shown here, antenna device 1 is clipped into a holder 33 on instrument panel using corresponding grooves shaped onto housing 32. The holder can be provided on instrument panel 20 at either one or multiple different locations. It is also possible firstly to adhesively bond holder 33 onto instrument panel 20 or, for example, attach it magnetically. In an embodiment, housing 32 has a lower part 34 and an upper part 35. By way of a rotation of upper part 35 with respect to lower part 34, in the context of a fixed lower part 34, a display depiction can be rotated about a rotation axis 36 drawn with dashed lines. An arrow depiction, for example, can thereby be oriented in a manner suitable for an observer. For illustration, an arrow for a rotation to the left 37 and an arrow for a rotation to the right 38 are depicted in the drawing. In a further embodiment, a lens optical system 39 is provided on the upper side of antenna device 1, between the display and windshield 21, for enlarged imaging. Even with a small antenna device, a virtual image that is to be depicted can thereby be enlarged. It is, however, also possible to embody the surface of the projection unit in planar fashion, indicated by dashed line 40. In a further embodiment, the distance of lens 39 from a light-generating device in the interior of antenna device 1 can also be made larger or smaller by a rotation in arrow direction 37 or 38 so that, in particular, the size of the virtual image can be modified.

In a further embodiment, antenna device 1 can also have an apparatus for switching on or off the projection device integrated into antenna device 1. In an embodiment, cover region 41 of antenna device 1 is shiftable in an axial direction 42 for this purpose. Cover 41 performs, in this context, the function of a pressure switch with which a contact in the interior of the antenna device is closed. The result thereof is to activate or deactivate projection.

Upon projection, light is radiated out of antenna device 1, depicted by way of example as a light beam 43, from antenna device 1 toward windshield 21, and is deflected thereby into an observer direction 44. A reflected and therefore virtual image is thereby visible, behind windshield 21, to an observer when he or she is looking opposite to arrow direction 44.

FIG. 4 depicts an example of an embodiment of display 2. An antenna device 50 has on its upper side a plurality of light-emitting diodes 51. Light-emitting diodes 51 can be operated in three groups. In the form depicted in FIG. 4, the light-emitting diodes that point to the right in the display area are being operated. It is also correspondingly possible to operate individual light-emitting diodes that, in a context of combined operation, respectively depict an arrow to the left or an arrow straight ahead. In a further embodiment, the point-source light-emitting diodes shown in FIG. 4 can also cover the entire area of the display. A variety of symbols can then be depicted in the display. FIG. 5 depicts a further exemplifying embodiment in which individual illuminated symbols 53 are already completely pre-shaped and can be provided, in individually activatable fashion, on a surface of an antenna device 52. The previously predefined symbols can correspondingly be activated by triggering via lead 23. Other planar light sources, for example electroluminescent light sources, can also be used instead of light-emitting diodes for the prefabricated symbols.

In addition to directional recommendations, warnings e.g. in the form of warning symbols can, in particular, also be overlaid into the windshield.

1-11. (canceled)

12. An antenna device for connection to a calculation device, comprising:
an antenna device arrangement, including:
a projection device for depicting a virtual image.

13. The antenna device of claim 12, wherein the projection device includes multiple light-emitting diodes to generate a light for depicting the virtual image.

14. The antenna device of claim 13, wherein the multiple light-emitting diodes are disposed on the antenna device arrangement so that multiple different symbols can be generated as the virtual image by at least partly separately triggering the multiple light-emitting diodes.

15. The antenna device of claim 12, wherein the antenna device arrangement is positionable independently of the calculation device.

16. The antenna device of claim 12, further comprising:
an interface between the antenna device arrangement and the calculation device is configured to at least one of (i) transfer information from the calculation device to the antenna device arrangement for introduction into the depicted virtual image, and (ii) transfer position information from the antenna device arrangement to the calculation device.

17. The antenna device of claim 12, further comprising:
an operating element for switching the projection device on and off.

18. The antenna device of claim 12, further comprising:
an optical device for adjusting the virtual image.

19. The antenna device of claim 12, further comprising:
a receiving unit for receiving a satellite signal of a positioning system.

20. The antenna device of claim 12, further comprising:
a receiving unit for receiving a traffic message data service.

21. The antenna device of claim 12, further comprising:
an attachment unit for attaching the antenna device arrangement to a dashboard of a motor vehicle.

22. An antenna device for connection to a calculation device in a motor vehicle, comprising:
an antenna device arrangement, including:
a projection device for depicting a virtual image.
